(19) United States
(12) Patent Application Publication
(10) Pub. No.: US 2017/0144119 A1
(43) Pub. Date: May 25, 2017

(54) GRANULAR MATERIAL AND METHOD OF PRODUCING GRANULAR MATERIAL

(71) Applicant: NISSHIN SEIFUN GROUP INC., Tokyo (JP)

(72) Inventors: Akihiko EMA, Fujimino-shi (JP); Yusuke IGAWA, Fujimino-shi (JP); Hitomi MEISAKU, Fujimi-shi (JP)

(73) Assignee: NISSHIN SEIFUN GROUP INC., Tokyo (JP)

(21) Appl. No.: 15/350,536

(22) Filed: Nov. 14, 2016

(30) Foreign Application Priority Data
Nov. 19, 2015 (JP) 2015-226619

(51) Int. Cl. B01J 2/02; C09C 1/30; C09C 3/04

(52) U.S. Cl. CPC B01J 2/02; C09C 3/045; C09C 1/3036; C01P 2004/61

(57) ABSTRACT

Including droplet and powder which has a liquid repellent property with respect to the droplet and is attached to the surface of the droplet.

### CROSS-REFERENCE TO RELATED APPLICATIONS

The disclosure of the following application claiming priority is incorporated by reference herein: Japanese Patent Application No. 2015-226619 filed on Nov. 19, 2015.

### TECHNICAL FIELD

The present invention relates to a granular material in which powder is attached to droplets and a method of producing the granular material.

### BACKGROUND ART

Conventionally, a technique of producing a granular material by mixing liquid and powder has been known. However, since it is difficult to uniformly mix liquid and powder, various mixing apparatuses and mixing methods have been proposed (see, for example, Patent Literature 1).

### CITATION LIST

### Patent Literature

Patent Literature 1: JP 2005-288367 A

### SUMMARY OF INVENTION

### Technical Problem

However, with the aforementioned mixing apparatus, for example, when liquid and a material having a property that repels the liquid (hereinafter, the liquid repellent property) are mixed like a combination of water and waxy material, there is a problem that the liquid is detached from the material or the material lumps after mixing, preventing uniform mixing of liquid and powder.

It is an object of the present invention to provide a granular material in which liquid and powder are uniformly mixed, and a method of producing the granular material.

### Solution to Problem

A granular material according to the present invention includes: a droplet; and powder having a liquid repellent property with respect to the droplet, the powder being attached to a surface of the droplet.

Furthermore, in the granular material according to the present invention, an angle of contact of the powder relative to the droplet is 90 degrees or more.

Furthermore, in the granular material according to the present invention, the droplet is a water drop formed of water and the powder is magnesium stearate powder.

Furthermore, in the granular material according to the present invention, the water drop has a median diameter D₅₀ of 10 to 50 μm and the magnesium stearate powder has a median diameter D₅₀ of 1 to 10 μm.

Furthermore, in the granular material according to the present invention, the droplet is an oil drop formed of oil and the powder is mica powder.

Furthermore, in the granular material according to the present invention, the oil drop has a median diameter D₅₀ of 10 to 50 μm and the mica powder has a median diameter D₅₀ of 1 to 10 μm.

Furthermore, a method of producing a granular material according to the present invention is a method of producing a granular material, the granular material including a droplet and powder having a liquid repellent property with respect to the droplet, the powder being mixed with the droplet, with a mixing apparatus for mixing the droplet and the powder, and the method includes: dispersing the powder from a powder dispersing portion arranged above an apparatus main body having an internal space into the internal space; spraying the droplet from a liquid spraying portion arranged in a vicinity of the powder dispersing portion into the internal space; and attaching the powder dispersed in the dispersing to a surface of the droplet sprayed in the spraying.

Furthermore, in the method of producing a granular material according to the present invention, the droplet has a median diameter D₅₀ of 10 to 50 μm and the powder has a median diameter D₅₀ of 1 to 10 μm.

Furthermore, in the method of producing a granular material according to the present invention, the droplet is a water drop famed of water and the powder is magnesium stearate powder.

Furthermore, in the method of producing a granular material according to the present invention, the droplet is an oil drop formed of oil and the powder is mica powder.

### Advantageous Effects of Invention

According to the present invention, a granular material in which liquid and powder are uniformly mixed and a method of producing the granular material are provided.

### BRIEF DESCRIPTION OF DRAWINGS

FIG. 1 is a conceptual view illustrating a granular material according to an embodiment;

FIG. 2 is a diagram illustrating an angle of contact between a droplet and a floor surface in a case where a droplet is dropped on the floor surface filled with powder having a liquid repellent property;

FIG. 3 is a diagram illustrating an angle of contact between a droplet and a floor surface in a case where a droplet is dropped on the floor surface filled with powder without a liquid repellent property;

FIG. 4 is a diagram illustrating a method of measuring an angle of contact between powder and a droplet;

FIG. 5 is a diagram illustrating a droplet photographed by a microscope;

FIG. 6 is a view of an internal structure of an apparatus according to an embodiment, viewed frontally;

FIG. 7 is a view of an internal structure of an apparatus according to an embodiment, viewed laterally;

FIG. 8 is a view illustrating an internal structure of an upper lid of an apparatus according to an embodiment;

FIG. 9 is a perspective view illustrating an exterior appearance of a bag filter provided in an apparatus main body according to an embodiment;

FIG. 10 is an exploded view of a structure of a discharge portion according to an embodiment, viewed from outside an apparatus main body;

FIG. 11 is a view of a structure of a discharge portion mounted on an apparatus main body according to an embodiment, viewed from above outside an apparatus main body;

FIG. 12 is a schematic view of a mixing system in which an apparatus according to an embodiment is viewed frontally;

FIG. 13 is a schematic view of a mixing system in which an apparatus according to an embodiment is viewed laterally;

FIG. 14 is a diagram indicating conditions of an experiment using an apparatus according to an embodiment;

FIG. 15 is a diagram indicating a particle size distribution of magnesium stearate powder used in an experiment using an apparatus according to an embodiment;

FIG. 16 is a photomicrograph of a granular material according to an embodiment, photographed at a magnification of 450;

FIG. 17 is a photomicrograph of a granular material according to an embodiment, photographed at a magnification of 1000; and

FIG. 18 is a diagram comparing experimental results of an experiment of an embodiment and a different experiment.

### DESCRIPTION OF EMBODIMENTS

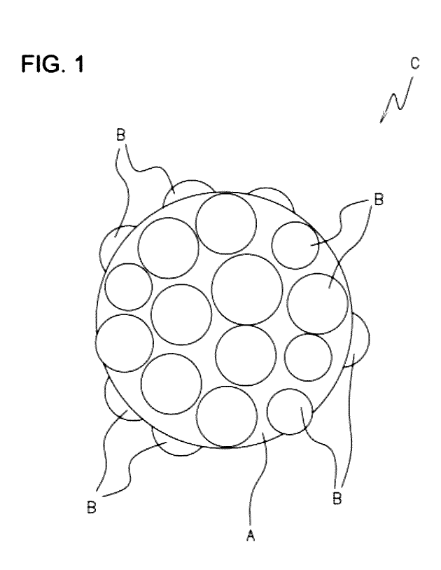

In the following, a granular material according to an embodiment of the present invention is described with reference to the drawings. FIG. 1 is a conceptual view illustrating a granular material according to the embodiment. As illustrated in FIG. 1, a granular material C is formed in such a manner that powder B having a liquid repellent property with respect to a droplet A is attached to the surface of the droplet A. An angle of contact of the powder B relative to the droplet A is 90 degrees or more. The angle of contact will be described later in detail.

When the droplet A is a water drop formed of water, magnesium stearate powder is used as the powder B. In this case, the water drop has a median diameter D₅₀ of 10 to 50 μm, and the magnesium stearate powder has a median diameter D₅₀ of 1 to 10 μm. Furthermore, an angle of contact of the magnesium stearate powder relative to the water drop is 90 degrees or more. The water described in the present embodiment includes an aqueous solution, e.g., salt water and scented water. The powder B may be powder other than the magnesium stearate powder insofar as the powder has a liquid repellent property with respect to water (hereinafter the water repellent property).

When the droplet A is an oil drop formed of oil, mica powder is used as the powder B. In this case, the oil drop has a median diameter D₅₀ of 10 to 50 μm, and the mica powder has a median diameter D₅₀ of 1 to 10 μm. Furthermore, an angle of contact of the mica powder relative to the oil drop is 90 degrees or more. The powder B may be powder other than the mica powder insofar as the powder has a liquid repellent property with respect to oil (hereinafter the oil repellent property).

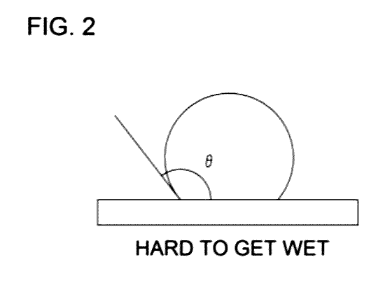

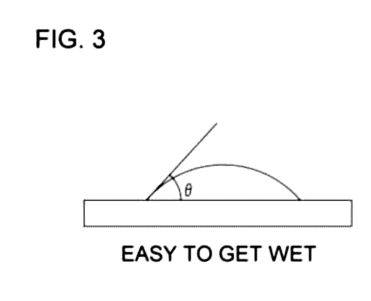

Next, the liquid repellent property of the powder is described. FIG. 2 is a diagram illustrating an angle of contact between a droplet and a floor surface in a case where a droplet is dropped on the floor surface filled with powder having the liquid repellent property. FIG. 3 is a diagram illustrating an angle of contact on a floor surface in a case where a droplet is dropped on the floor surface filled with powder without the liquid repellent property.

The liquid repellent property of the powder is increased as the angle of contact θ illustrated in FIGS. 2 and 3 approaches 180 degrees. Therefore, when the angle of contact θ is large as illustrated in FIG. 2, the powder does not easily get wet and has a high liquid repellent property. When the angle of contact θ is small as illustrated in FIG. 3, the powder easily gets wet and has a low liquid repellent property.

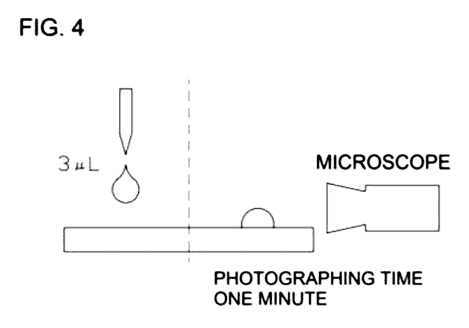

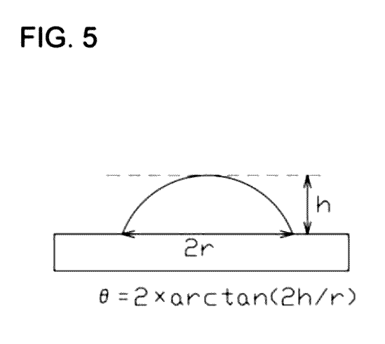

FIG. 4 is a diagram illustrating a method of measuring an angle of contact (JIS 3257:1999). As illustrated in FIG. 4, an angle of contact is measured, for example, in such a manner that a droplet of 3 μL is dropped from a dropper on a floor surface filled with powder and is photographed within one minute with a microscope. FIG. 5 is a diagram illustrating a droplet photographed by a microscope. The angle of contact θ is determined by θ=2×arctan (2 h/r) using a diameter 2r and a height h of a droplet.

The angle of contact θ of the magnesium stearate powder relative to the water drop is 90 degrees or more, and the magnesium stearate powder has a high water repellent property. Furthermore, the angle of contact θ of the mica powder relative to the oil drop is 90 degrees or more, and the mica powder has a high oil repellent property. Therefore, both when the magnesium stearate powder is attached to the surface of the water drop and when the mica powder is attached to the surface of the oil drop, the powder B does not get wet and is attached to the surface of the droplet A.

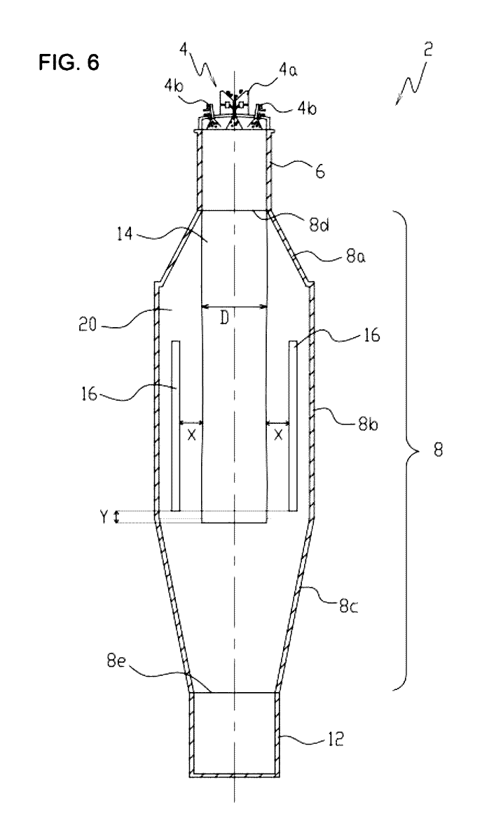

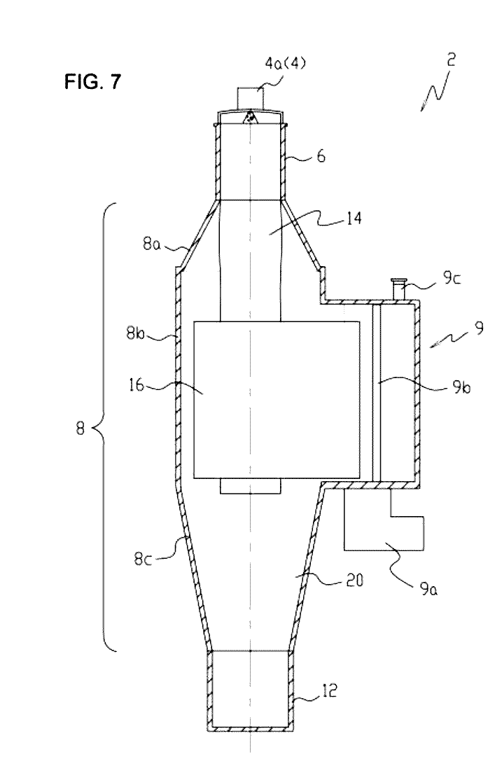

Next, a mixing apparatus according to an embodiment of the present invention is described with reference to the drawings. FIG. 6 is a view of an internal structure of the mixing apparatus, viewed frontally. FIG. 7 is a view of an internal structure of the mixing apparatus, viewed laterally. As illustrated in FIGS. 6 and 7, a mixing apparatus 2 includes an upper lid 4, an introduction pipe 6, an apparatus main body 8, a discharge portion 9, and a collection container 12.

The upper lid 4 is a lid for closing an upper end of the introduction pipe 6. In the upper lid 4, a powder disperser 4a for supplying powders in a dispersing manner into the apparatus main body 8 and liquid atomizing nozzles 4b for spraying atomized liquid into the apparatus main body 8 are arranged.

The introduction pipe 6 is a cylindrical pipe for introducing the powders supplied from the powder disperser 4a and the liquid sprayed from the liquid atomizing nozzles 4b, into the apparatus main body 8. The introduction pipe 6 has an outside diameter D of about 300 mm. The introduction pipe 6 has a length L₆ of about 300 mm.

The apparatus main body 8 includes three cylindrical shell portions: an upper cylindrical shell portion 8a having a truncated square pyramidal shape, an intermediate cylindrical shell portion 8b having a rectangular cylindrical shape, and a lower cylindrical shell portion 8c having an inverted truncated square pyramidal shape. A top of the upper cylindrical shell portion 8a is famed with an opening 8d for introducing the powders and the liquid in the introduction pipe 6 into the apparatus main body 8. A lower end of the lower cylindrical shell portion 8c is famed with an opening 8e for discharging mixed powders to be collected by the collection container 12.

Furthermore, in the apparatus main body 8, a cylindrical member 14 for preventing the droplets A, the powders B, and the granular materials C from being dispersed into an internal space 20 of the apparatus main body 8, and bag filters 16 through which a discharge flow passes are arranged. The cylindrical member 14 is formed of a non-woven fabric having a bore diameter almost equivalent to that of the introduction pipe 6. The cylindrical member 14 is arranged in the internal space 20 with one end facing upward and the other end facing downward. The one end and the other end are opened to allow the droplets A, the powders B, and the granular materials C to flow. Furthermore, two bag filters 16 are arranged at positions across the cylindrical member 14 of the internal space 20 where a distance X with respect to the cylindrical member 14 is 100 mm in actual measurement (X/D=0.33). The cylindrical member 14 is arranged so that the one end is connected to the introduction pipe 6 and the other end is positioned between the lower end of the bag filters 16 and the collection container 12. The bag filters 16 are arranged at positions where a distance Y between the lower end of the bag filters 16 and the other end of the cylindrical member 14 is 50 mm in actual measurement. The cylindrical member 14 has a length L₁₄ of about 700 mm. However, the length is not limited to the above, but may be selected from a length of L₄₄/D>1.

The discharge portion 9 is provided on an outer wall portion of the intemediate cylindrical shell portion 8b of the apparatus main body 8. An accumulator 9a is arranged on a lower part of the discharge portion 9, and a discharge pipe 9c for discharging air in the internal space 20 is arranged on an upper part of the discharge portion 9. Furthermore, inside the discharge portion 9, an air pipe 9b for supplying pulsed compressed air, which is introduced from the accumulator 9a, to the bag filters 16 is arranged.

The collection container 12 is arranged below the lower cylindrical shell portion 8c and collects the granular materials C mixed in the introduction pipe 6 and the cylindrical member 14.

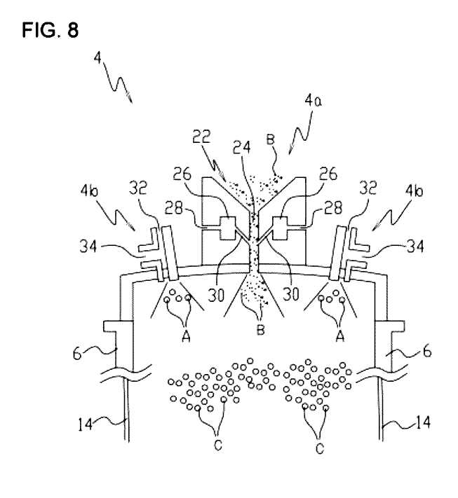

FIG. 8 is a view illustrating an internal structure of the upper lid 4. As illustrated in FIG. 8, at a roughly central part of the upper lid 4, the powder disperser 4a, a device for dispersing the powders into primary particles, is arranged. In the vicinity of the powder disperser 4a, two liquid atomizing nozzles 4b for generating droplets are arranged across the powder disperser 4a. The powder disperser 4a and the liquid atomizing nozzles 4b are arranged at an angle at which the disperse direction of the powders dispersed from the powder disperser 4a and the primary spray direction of the liquid sprayed from the liquid atomizing nozzles 4b make an acute angle with respect to one another so that the powders collide with the liquid with high probability.

An upper part of the powder disperser 4a is formed with a powder supply port 22 having an inverted conical shape. At a roughly central part of the interior of the powder disperser 4a, a powder passage 24 through which the powder supply port 22 is communicated with the interior of the introduction pipe 6 is formed. Furthermore, inside the powder disperser 4a, an air chamber 26, which is an air reservoir for ejecting air at a uniform pressure, an air inlet port 28 for introducing air into the air chamber 26, and a slit 30 through which the air chamber 26 is communicated with the powder passage 24 are famed. The slit 30 is famed in an annular shape around the powder passage 24 and is communicated with the powder passage 24 and the air chamber 26 roughly circumferentially. The air chamber 26 is also famed in an annular shape around the powder passage 24. The air chamber 26 ejects the air introduced from the air inlet port 28 at a uniform pressure across the entire circumference of the slit 30.

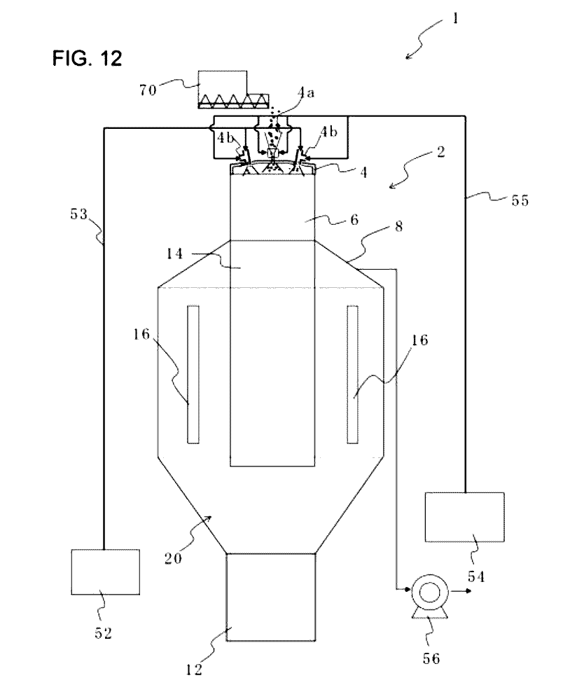

The liquid atomizing nozzle 4b is a two-fluid type nozzle including a liquid passage 32 through which the liquid introduced from a liquid supply pipe 53 (see FIG. 12) passes and an air passage 34 for injecting at high speed the compressed air introduced from an air pipe 55 (see FIG. 12) into the liquid passage 32. The liquid atomizing nozzle 4b is not limited to the two-fluid type, but other spray types such as a one-fluid type nozzle using a high-pressure pump and an ultrasonic spray type nozzle may be employed. When oils and fats or the like which are solid at room temperature are used, they are melted by a heater or the like and are transported with a pump.

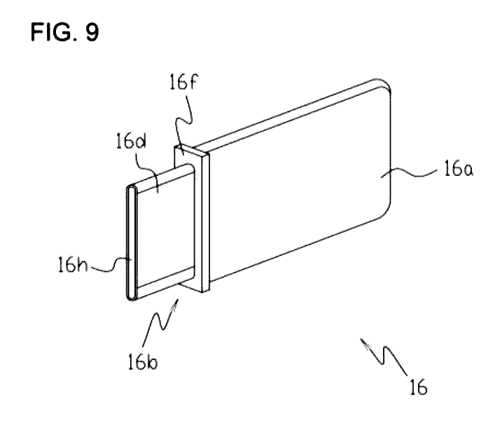

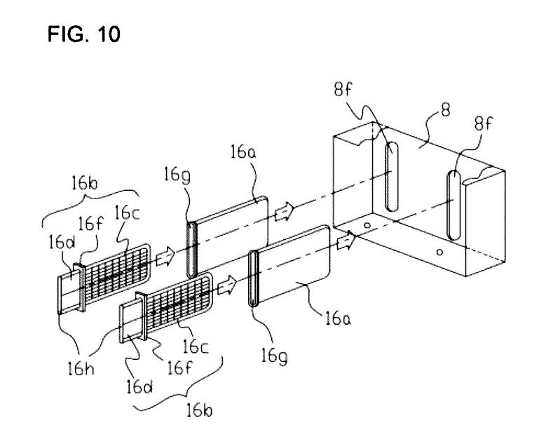

FIG. 9 is a perspective view illustrating an exterior appearance of the bag filter 16. FIG. 10 is an exploded view of a structure of the discharge portion 9, viewed from outside the apparatus main body 8. The bag filter 16 is configured such that a main body portion 16b is covered with a bag-shaped fabric 16a. As illustrated in FIG. 10, the main body portion 16b includes a grid-shaped frame 16c, a cylindrical portion 16d including therein a space 16h having a roughly rectangular shape in cross-section, and a fixation portion 16f fixed to the apparatus main body 8.

As illustrated in FIG. 10, the bag filter 16 is mounted on the apparatus main body 8 in such a manner that, the fabric 16a is put on the frame 16c, the frame 16c covered with the fabric 16a is inserted into an opening 8f famed through the outer wall of the apparatus main body 8, and the fixation portion 16f is fixed to the outer wall of the apparatus main body 8. The bag filter 16 is not limited to a quadrangular prism shape, but other shapes such as a cylindrical shape may be employed.

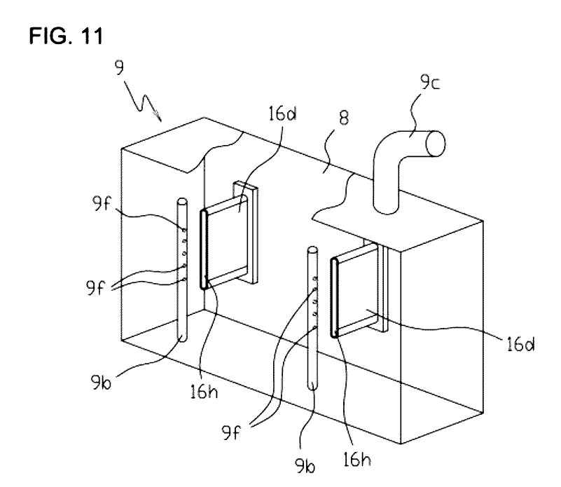

FIG. 11 is a view of a structure of the discharge portion 9, viewed from above outside the apparatus main body 8. As illustrated in FIG. 11, a discharge pipe 9c is arranged on an upper part of the discharge portion 9, and inside the discharge portion 9, air pipes 9b extending upward through the outer wall of a lower part of the discharge portion 9 are arranged. Furthermore, since the bag filters 16 are mounted on the apparatus main body 8 such that the frame 16c covered with the fabric 16a is inserted into the internal space 20, the cylindrical portion 16d of the bag filter 16 is positioned near the outer wall of the apparatus main body 8 inside the discharge portion 9. As a blower 56 (see FIG. 12) is driven, the air in the internal space 20 of the apparatus main body 8 is discharged to the outside via the fabric 16a, the space between the fabric 16a and the frame 16c of the bag filter 16, which is not illustrated, the space 16h, the internal space of the discharge portion 9, and the discharge pipe 9c.

Furthermore, pulsed compressed air is introduced into the air pipe 9b from the accumulator 9a at predetermined time intervals. The pulsed compressed air introduced into the air pipe 9b is ejected into the space 16h through holes 9f famed through the air pipe 9b and is delivered into the space between the fabric 16a and the frame 16c via the space 16h. Thus, the fabric 16a is temporarily expanded and the powders adhered to the fabric 16a are removed by the oscillation of the fabric 16a. Thus, the air permeability of the fabric 16a is maintained. Therefore, clogging of the fabric 16a of the bag filter 16 is suppressed during discharge to the outside via the fabric 16a of the bag filter 16, the space between the fabric 16a and the frame 16c, the space 16h, the internal space of the discharge portion 9, and the discharge pipe 9c, thereby enabling suppression of a reduction in discharge force of the blower 56.

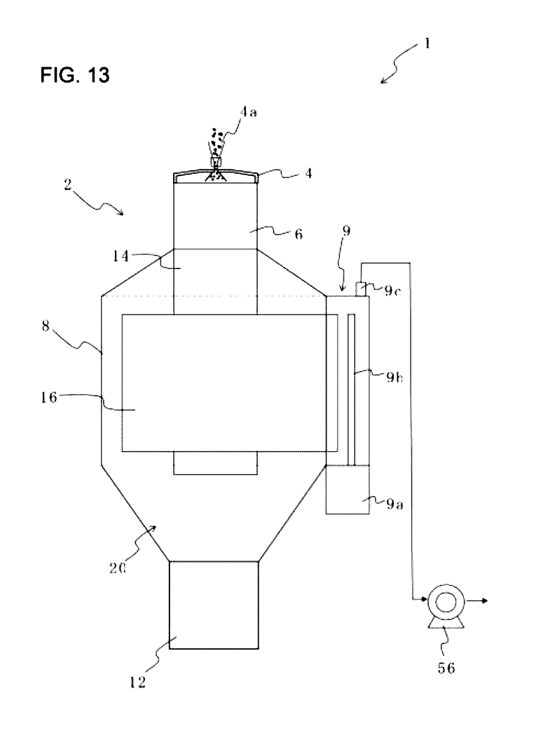

FIG. 12 is a schematic view of a mixing system in which the mixing apparatus 2 is viewed frontally. FIG. 13 is a schematic view of a mixing system in which the mixing apparatus 2 is viewed laterally. For prevention of uneven flow in the cylindrical member 14, it is preferable that the bag filters 16 are arranged axisymmetrically relative to the central axis of the cylindrical member 14 or symmetrically relative to a plane including the central axis of the cylindrical member 14.

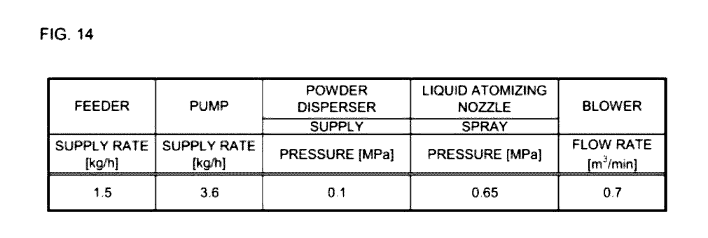

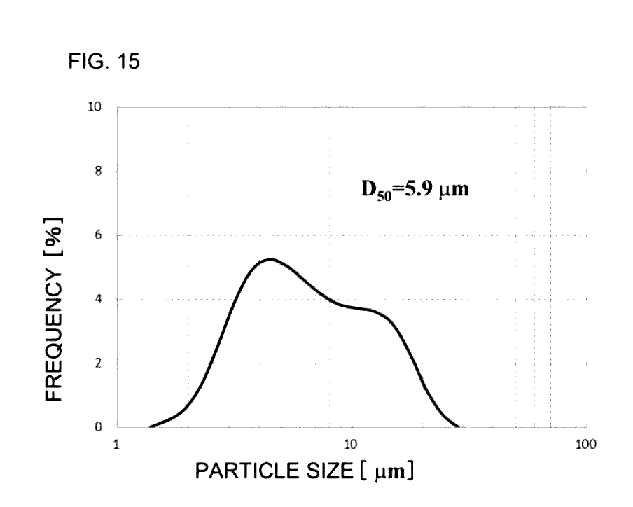

A process of generating a granular material with the mixing apparatus 2 according to the embodiment is described with reference to the schematic views of the mixing system illustrated in FIGS. 12 and 13. Herein, an example of a case is described where an experiment was conducted under the conditions indicated in FIG. 14 using magnesium stearate powder as powder and water as liquid. Furthermore, as illustrated in FIG. 15, the magnesium stearate powder used in the experiment has a median diameter D₅₀ of 5.9 μm.

First, when the operation of a mixing system 1 is started, both a compressed air supply portion 54 and the blower 56 are driven. When the compressed air supply portion 54 is driven, compressed air is introduced into the air passages 34 of the liquid atomizing nozzles 4b from the air pipe 55, and compressed air is introduced into the air inlet port 28 of the powder disperser 4a from the air pipe 55.

The compressed air introduced into the air inlet port 28 is ejected through the slit 30 at uniform ejection pressure by the air chamber 26 and is discharged into the introduction pipe 6 via the powder passage 24.

Furthermore, when the blower 56 is driven, the air in the internal space 20 of the apparatus main body 8 is discharged to the outside. The air in the internal space 20 passes through the fabric 16a put on the bag filter 16 and is then discharged to the outside via the space between the fabric 16a and the frame 16c, the space 16h, the internal space of the discharge portion 9, and the discharge pipe 9c. As illustrated in FIG. 14, the blower 56 discharges the air of the internal space 20 at a flow rate of 0.7 m³/min.

Next, when the magnesium stearate powders are supplied to the powder supply port 22 from a feeder 70, as illustrated in FIG. 8, the powders B of magnesium stearate are sucked into the powder passage 24 by a high-speed airstream ejected through the slit 30 and are dispersed into the introduction pipe 6. As illustrated in FIG. 14, the powders B are supplied from the feeder 70 at a supply rate of 1.5 kg/h and are dispersed from the powder disperser 4a at an air pressure of 0.1 MPa together with the compressed air.

Next, when a pump 52 is driven, water is supplied from the liquid supply pipe 53 to the liquid passages 32 (see FIG. 8) of the liquid atomizing nozzles 4b. As illustrated in FIG. 14, the water is supplied to the liquid supply pipe 53 from the pump 52 at a supply rate of 3.6 kg/h.

The water passing through the liquid passages 32 of the liquid atomizing nozzles 4b is atomized by the compressed air injected from the air passages 34 at high speed, and, as illustrated in FIG. 8, is sprayed into the introduction pipe 6 as the droplets A. As illustrated in FIG. 14, the droplets A are sprayed from the liquid atomizing nozzles 4b at a pressure of 0.65 MPa. Furthermore, the droplets A have a median diameter D₅₀ of about 10 to 30 μm.

The supply rate of the powders supplied from the feeder 70 is 1.5 kg/h and the supply rate of the water supplied from the pump 52 is 3.6 kg/h. Thus, a ratio of the supply rate of the powders to the supply rate of the water is roughly 1:2.

The droplets A sprayed into the introduction pipe 6 from the liquid atomizing nozzles 4b and the powders B dispersed into the introduction pipe 6 from the powder disperser 4a are mixed in the introduction pipe 6 or in the cylindrical member 14, and the powders B are attached to the surfaces of the droplets A. Since the magnesium stearate powders have a water repellent property, the powders B do not get wet. As illustrated in FIG. 1, the granular material C is famed as the powders B are attached to the surface of the droplet A. Next, as illustrated in FIG. 8, the granular materials C fall by their own weight into the introduction pipe 6 and the cylindrical member 14, and are then collected by the collection container 12.

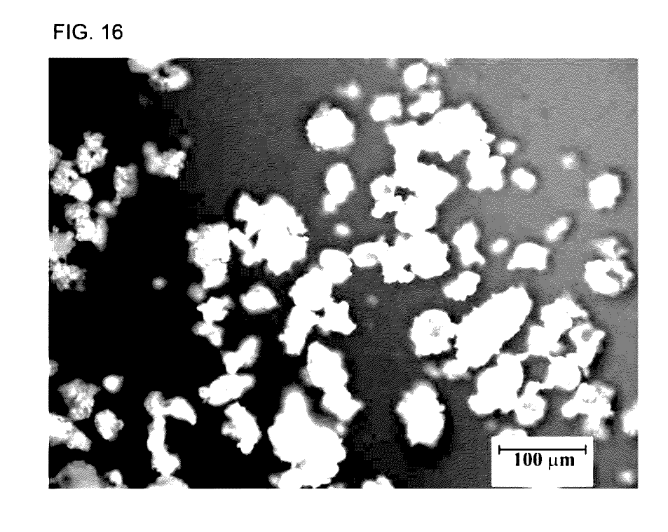

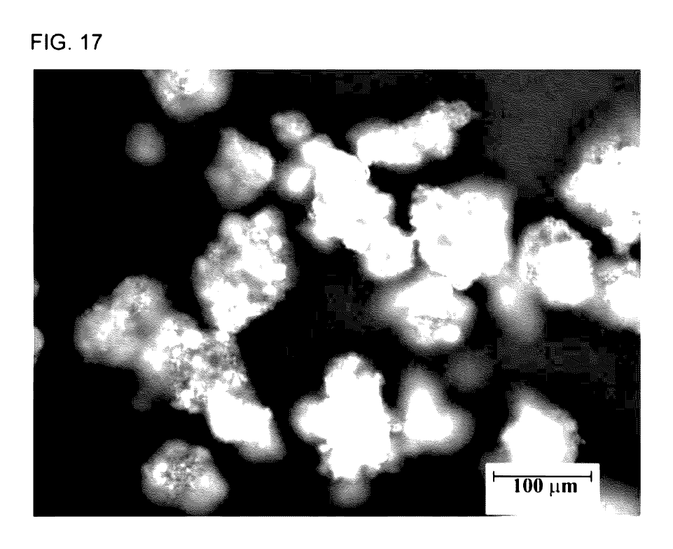

FIG. 16 is a photomicrograph of the surfaces of the granular materials C photographed at a magnification of 450. FIG. 17 is a photomicrograph of the surfaces of the granular materials C photographed at a magnification of 1000. In the photomicrographs, the portions viewed in white are the granular materials C, and the portions viewed in black are the base. As an experiment is conducted under the conditions indicated in FIG. 14, as illustrated in FIGS. 16 and 17, the granular materials C in which the powders B are uniformly attached to the surfaces of the droplets A are obtained stably over long periods of time.

According to the production method of the present embodiment, the droplet A and the powder B having the liquid repellent property with respect to the droplet A are uniformly mixed with the mixing apparatus 2 so that the powder B is attached to the surface of the droplet A. Thus, the granular material C retaining the nature as powder is produced while the powder B is not detached from the droplet A or the powder B does not lump.

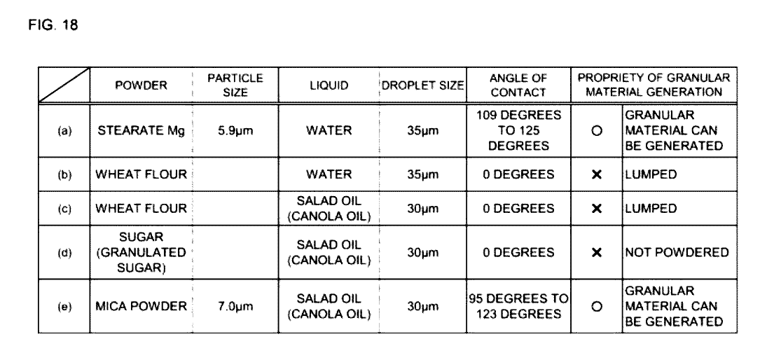

FIG. 18 is a diagram comparing experimental results of an experiment of the embodiment and a different experiment. In FIG. 18, (a) is the results of an experiment of the present invention in which magnesium stearate powder was used as powder and water was used as liquid, (b) is the results of an experiment in which wheat flour was used as powder and water was used as liquid, (c) is the results of an experiment in which wheat flour was used as powder and salad oil (canola oil manufactured by The Nisshin OilliO Group, Ltd.) (hereinafter, salad oil) was used as liquid, (d) is the results of an experiment in which sugar (granulated sugar) (hereinafter sugar) was used as powder and salad oil was used as liquid, and (e) is the results of an experiment in which mica powder was used as powder and salad oil was used as liquid.

In the experiments, the magnesium stearate powder used as indicated in (a) had a median diameter D₅₀ of 5.9 μm, and the mica powder used as indicated in (e) had a median diameter D₅₀ of 7.0 μm. Furthermore, the droplet famed of water indicated in (a) and (b) had a median diameter D₅₀ of 35 μm, and the oil droplet of salad oil indicated in (c) to (e) had a median diameter D₅₀ of 30 μm.

According to the experimental results, when the magnesium stearate powder was used as powder and water was used as liquid as in the present embodiment, as indicated in (a), an angle of contact of the magnesium stearate powder relative to the water drop was 109 to 125 degrees, enabling the production of a granular material in which the powder is attached to the surface of the droplet. Meanwhile, when an experiment was conducted using the powder-liquid combinations indicated in (b) to (d), an angle of contact of the powder relative to the droplet was zero degree, and a granular material could not be produced.

Specifically, as in (b), when wheat flour was used as powder and water was used as liquid, the water was soaked into the wheat flour and the wheat flour lumped. Thus, unlike the present embodiment, a granular material could not be produced. Similarly, as in (c), when wheat flour was used as powder and salad oil was used as liquid, the salad oil was soaked into the wheat flour and the wheat flour lumped. Thus, unlike the present embodiment, a granular material could not be produced.

Furthermore, as in (d), when sugar was used as powder and salad oil was used as liquid, the salad oil was soaked into the sugar and the sugar was not powdered. Thus, unlike the present embodiment, a granular material could not be produced.

When mica powder is used as powder and salad oil is used as liquid, as indicated in (e), an angle of contact of the mica powder relative to the oil drop is 95 to 123 degrees, enabling the production of a granular material in which the powder is attached to the surface of the droplet.

Furthermore, in the aforementioned embodiment, as indicated in FIG. 14, an example of an experiment is described in which, as the supply rates of the magnesium stearate powder and the water, one part by weight of magnesium stearate powder (1.5 kg/h) is supplied and about two parts by weight of water (3.6 kg/h) is supplied. However, the granular material C can be produced even at different supply rates. For example, a granular material can be naturally produced even when the part by weight of water is reduced relative to the part by weight of magnesium stearate powder.

Furthermore, also in cases where an aqueous solution such as salt water and scented water is used instead of water, a granular material can be similarly produced insofar as an angle of contact between the magnesium stearate powder and the aqueous solution exceeds 90 degrees.

Furthermore, also in cases where oil is used as liquid in the same experiment as the aforementioned experiment of the embodiment, a granular material can be similarly produced insofar as an angle of contact between the oil and the powder exceeds 90 degrees.

Furthermore, in the aforementioned embodiment, an example of a case is described in which the droplet A (water drop) famed of water or aqueous solution has a median diameter D₅₀ of 10 to 50 μm. However, the granular material C can be produced even when the nozzle pressure of the liquid atomizing nozzle 4b is reduced and the droplet A (water drop) has a median diameter D₅₀ of 50 μm or more.

Furthermore, in the aforementioned embodiment, the bag filters 16 do not necessarily have to be arranged at positions where the distance X with respect to the cylindrical member 14 is 100 mm in actual measurement. It is sufficient that the bag filters 16 are arranged at positions where a ratio (X/D) of the diameter D of the cylindrical member 14 to the distance X with respect to the cylindrical member 14 is 0.1 or more.

Furthermore, in the aforementioned embodiment, it is sufficient that the bag filters 16 are arranged at positions where a ratio (Y/D) of the distance Y between the lower end of the bag filter 16 and the other end of the cylindrical member 14 to the diameter D of the cylindrical member is zero or more. However, the bag filters 16 are preferably arranged at positions where Y/D is 0.1 or more, more preferably arranged at positions where Y/D is 0.3 or more.

Furthermore, in the aforementioned embodiment, an example of a case is described in which the cylindrical member 14 has a cylindrical shape. However, the cylindrical member 14 may not necessarily have a cylindrical shape.

The embodiment described heretofore is described for the sake of easy understanding of the present invention, but is not described to limit the present invention. Therefore, the elements disclosed in the aforementioned embodiment include every design variation and equivalent falling within the technical scope of the present invention.

1. A granular material comprising:
a droplet; and
powder having a liquid repellent property with respect to the droplet, the powder being attached to a surface of the droplet.

2. The granular material according to claim 1, wherein an angle of contact of the powder relative to the droplet is 90 degrees or more.

3. The granular material according to claim 1, wherein the droplet is a water drop famed of water and the powder is magnesium stearate powder.

4. The granular material according to claim 2, wherein the droplet is a water drop foiled of water and the powder is magnesium stearate powder.

5. The granular material according to claim 3, wherein the water drop has a median diameter D₅₀ of 10 to 50 μm and the magnesium stearate powder has a median diameter D₅₀ of 1 to 10 μm.

6. The granular material according to claim 4, wherein the water drop has a median diameter D₅₀ of 10 to 50 μm and the magnesium stearate powder has a median diameter D₅₀ of 1 to 10 μm.

7. The granular material according to claim 1, wherein the droplet is an oil drop famed of oil and the powder is mica powder.

8. The granular material according to claim 2, wherein the droplet is an oil drop famed of oil and the powder is mica powder.

9. The granular material according to claim 7, wherein the oil drop has a median diameter D₅₀ of 10 to 50 μm and the mica powder has a median diameter D₅₀ of 1 to 10 μm.

10. The granular material according to claim 8, wherein the oil drop has a median diameter D₅₀ of 10 to 50 μm and the mica powder has a median diameter D₅₀ of 1 to 10 μm.

11. A method of producing a granular material, the granular material including a droplet and powder having a liquid repellent property with respect to the droplet, the powder being mixed with the droplet, with a mixing apparatus for mixing the droplet and the powder, the method comprising:
dispersing the powder from a powder dispersing portion arranged above an apparatus main body having an internal space into the internal space;
spraying the droplet from a liquid spraying portion arranged in a vicinity of the powder dispersing portion into the internal space; and
attaching the powder dispersed in the dispersing to a surface of the droplet sprayed in the spraying.

12. The method of producing a granular material according to claim 11, wherein the droplet has a median diameter D₅₀ of 10 to 50 μm and the powder has a median diameter D₅₀ of 1 to 10 μm.

13. The method of producing a granular material according to claim 11, wherein the droplet is a water drop famed of water and the powder is magnesium stearate powder.

14. The method of producing a granular material according to claim 12, wherein the droplet is a water drop famed of water and the powder is magnesium stearate powder.

15. The method of producing a granular material according to claim 11, wherein the droplet is an oil drop foiled of oil and the powder is mica powder.

16. The method of producing a granular material according to claim 12, wherein the droplet is an oil drop famed of oil and the powder is mica powder.
